(19) United States
(12) Patent Application Publication
(10) Pub. No.: US 2008/0259664 A1
(43) Pub. Date: Oct. 23, 2008

(54) NETWORK TRANSMIT/RECEIVE PORT

(76) Inventor: Timothy Su, Tucson, AZ (US)

Correspondence Address: RABIN & Berdo, PC, 1101 14TH STREET, NW, SUITE 500, WASHINGTON, DC, 20005, US

(21) Appl. No.: 11/741,071

(22) Filed: Apr. 27, 2007

Related U.S. Application Data
(63) Continuation-in-part of application No. 11/737,863, filed on Apr. 20, 2007, now abandoned.

(51) Int. Cl. H02M 7/06

(52) U.S. Cl. 363/126; 363/125

(57) ABSTRACT

A network transmit/receive port, including transformers, a rectifying unit, a powered device controller unit, and a DC-DC converter controller, is provided. Each circuit unit is integrated in a network transmit/receive port of an Ethernet power sourcing/powered device, so as to reduce the volume of externally-connected circuits, which thus further satisfies the product design trend of being short, small, light, and thin.

### CROSS-REFERENCE TO RELATED APPLICATIONS

This application is a continuation-in-part patent application of U.S. application Ser. No. 11/737,863 filed on Apr. 20, 2007, the entire contents of which are hereby incorporated by reference for which priority is claimed under 35 U.S.C. §120.

### BACKGROUND OF THE INVENTION

1. Field of the Invention

The present invention relates to a signal transmit/receive port. More particularly, the present invention relates to a network transmit/receive port that conforms to an 802.3af protocol stipulated by the Institute of Electrical and Electronics Engineers (IEEE).

2. Related Art

As the development of Internet, various electronics taking Ethernet as the data transmission interface have gradually become popular, and most of them require an external independent power supply for the normal operations. In this manner, when being used, the electronic equipment is affected and restricted by the position of the external power supply, and it cannot be freely disposed at any position. Therefore, in 2003, the IEEE stipulates an 802.3af protocol, which mainly aims at specifying application technologies about the Ethernet cable in simultaneously delivering the electric power and the data signal. The electronic equipment powered through the Ethernet cable can be directly used, without requiring any additional power supply socket, such that the whole system has a lower cost.

Recently, a Power over Ethernet (PoE) apparatus includes a connecting element, a power supply control circuit, a network control circuit, a filter circuit, and a pin group. The connecting element is connected to an external network. The power supply control circuit is connected to an external power supply device, and outputs the power of the external power supply device. The filter circuit is respectively electrically connected to the connecting element and the power supply control circuit, which is used to filter noises in the network signal, and supply a direct current (DC) voltage with a stable load. The network control circuit, connected to the filter circuit, is used to perform the network signal and data conversion. The pin group, formed by a plurality of pins, is connected to the network control circuit. Although the PoE apparatus has advantage of not being restricted by the electrical wiring or the position of the power supply socket, since the connecting element, the power supply control circuit, the network control circuit, the filter circuit, and the pin group are disposed on the same circuit board, it is difficult for the size and the volume of the whole PoE apparatus to satisfy the product design trend of being short, small, light, and thin.

Therefore, it is an urgent problem to be solved by the researchers about how to reduce the size and the volume of the Ethernet power sourcing/powered device.

### SUMMARY OF THE INVENTION

In view of the above problems, the present invention is directed to a network transmit/receive port, which is capable of integrating a part of circuit modules in an Ethernet power sourcing/powered device into the network transmit/receive port, so as to reduce the size and the volume of a circuit board for the Ethernet power sourcing/powered device, and thereby satisfying the product design trend of being short, small, light, and thin.

The present invention provides a network transmit/receive port, which includes: a printed circuit board; transformers, for directing power and coupling and filtering data to a physical layer device; and a rectifying unit, disposed on the printed circuit board, and electrically coupled to the transformer and/or spare lines for accepting power of either polarity at each of its inputs from the transformers and/or spare lines; and a case, for accommodating the transformers, and the rectifying unit.

In one embodiment, the network transmit/receive port further includes a powered device controller unit, electrically coupled to the rectifying unit, for receiving the DC power and stabilizing the voltage value of the DC power within a default scope.

In one embodiment, the network transmit/receive port further includes a DC-DC converter controller, electrically coupled to the powered device controller, for controlling a first voltage value of the DC voltage into a second voltage value for outputting.

With the network transmit/receive port of the present invention, the transformers, the rectifying unit, the powered device controller unit, and the DC-DC converter controller are disposed within the residual space of the network transmit/receive port, so as to reduce the size and the volume of the circuit board for the Ethernet power sourcing/powered device. Therefore, not only the integration of the network transmit/receive port is improved, but the network transmit/receive port is also made to have various functions such as noise isolating, rectifying, voltage stabilizing, and voltage converting, which invisibly enhances the competitive advantage of the electronic product.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is a block diagram of a system according to a first embodiment of the present invention;

FIG. 1B is a block diagram of a system according to a second embodiment of the present invention;

FIG. 1C is a block diagram of a system according to a third embodiment of the present invention; and

FIG. 2 is a schematic cross-sectional view of a structure according to the embodiment of the present invention.

### DETAILED DESCRIPTION OF THE INVENTION

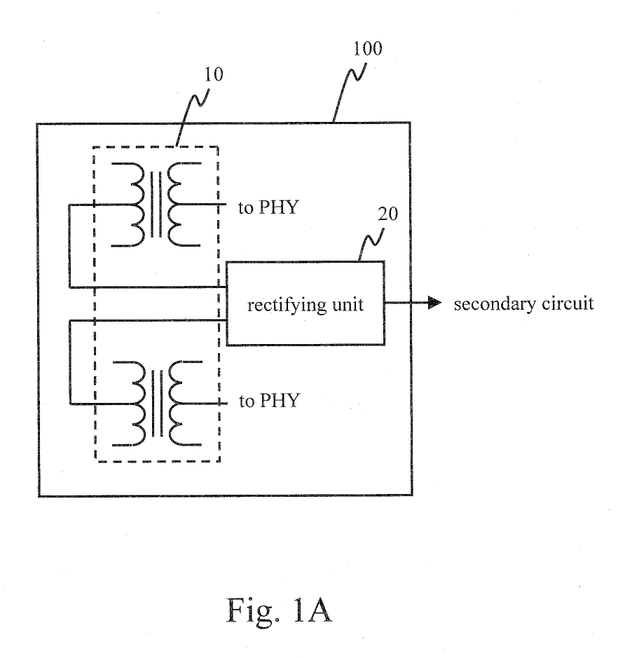

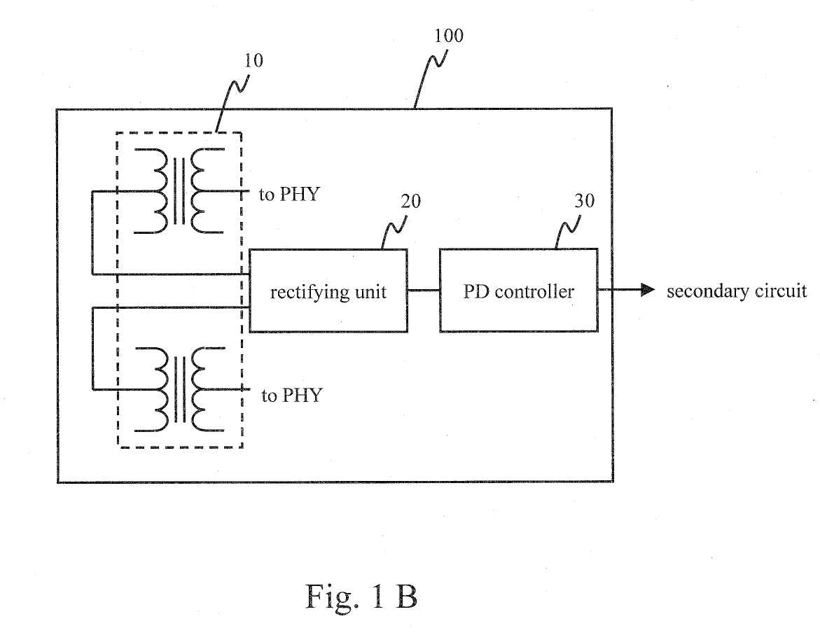

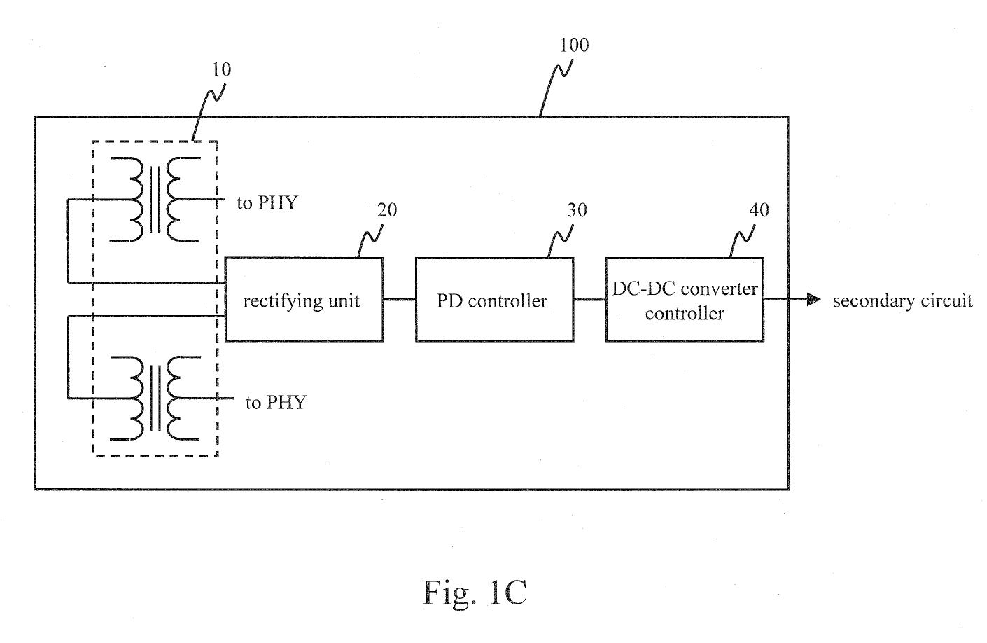

Referring to FIG. 1A, it is a block diagram of a system according to a first embodiment of the present invention. As shown in FIG. 1A, the network transmit/receive port 100 of the present invention includes transformers 10 and a rectifying unit 20, and the network transmit/receive port 100 is disposed on an electronic device of the power sourcing end or on an electronic device of the powered end.

The transformers 10 is disposed in the network transmit/receive port 100, and has an input end and an output end of different groups of coils. The input end is used to receive one or more groups of direct current (DC) power supply voltage signals and data signals, and to direct power to rectifying unit and couple and filter data to a physical layer device (PHY).

The rectifying unit 20 is disposed on a circuit board (not shown) in the network transmit/receive port 100, and electrically coupled to the transformers 10 or third connection pins 53, for accepting power of either polarity at each of its inputs and output to a secondary circuit (for example, the powered device controller, the DC-DC converter controller, transformer, etc.). The rectifying unit 20 is, for example, a half wave rectifier or a full wave rectifier formed by a diode circuit, and preferably, a full wave bridge rectifier.

Referring to FIG. 1B, it is a block diagram of a system according to a second embodiment of the present invention. As shown in FIG. 1B, the network transmit/receive port of the present invention includes the transformers 10, the rectifying unit 20, and a powered device controller unit 30. The network transmit/receive port 100 is disposed on an electronic device of the powered end.

The transformers 10 is disposed in the network transmit/receive port 100, and has an input end and an output end of different groups of coils. The input end is used to receive one or more groups of direct current (DC) power supply voltage signals and data signals, and to direct power to rectifying unit and couple and filter data to PHY

The rectifying unit 20 is disposed on a circuit board (not shown) in the network transmit/receive port 100, and electrically coupled to the transformers 10 or third connection pins 53, for accepting power of either polarity at each of its inputs and output to a secondary circuit (for example, the PD controller, the DC-DC converter controller, transformer, etc.). The rectifying unit 20 is, for example, a half wave rectifier or a full wave rectifier formed by a diode circuit, and preferably, a full wave bridge rectifier.

The powered device controller unit 30 is disposed on the circuit board (not shown) in the network transmit port 100, and electrically coupled to the rectifying unit 20, for providing a resistance for signature detection, providing classification currents for power classification, providing powered device full power, and managing power and thermal protection overrides, including UVLO (under voltage lockout).

Referring to FIG. 1C, it is a block diagram of a system according to a third embodiment of the present invention. As shown in FIG. 1C, the network transmit/receive port of the present invention includes the transformers 10, the rectifying unit 20, and the powered device controller unit 30, and a DC-DC converter controller 40. The network transmit/receive port 100 is disposed on an electronic device of the powered end.

The transformers 10 is disposed in the network transmit/receive port 100, and has an input end and an output end of different groups of coils. The input end is used to receive one or more groups of direct current (DC) power supply voltage signals and data signals, and to direct power to rectifying unit and couple and filter data to PHY The rectifying unit 20 is disposed on a circuit board (not shown) in the network transmit/receive port 100, and electrically coupled to the transformers 10 or third connection pins 53, for accepting power of either polarity at each of its inputs and output to a secondary circuit (for example, the PD controller, the DC-DC converter controller, transformer, etc.). The rectifying unit 20 is, for example, a half wave rectifier or a full wave rectifier formed by a diode circuit, and preferably, a full wave bridge rectifier.

The powered device controller unit 30 is disposed on the circuit board (not shown) in the network transmit/receive port 100, and electrically coupled to the rectifying unit 20, for providing a resistance for signature detection, providing classification currents for power classification, providing powered device full power, and managing power and thermal protection overrides, including UVLO (under voltage lockout).

The DC-DC converter controller 40 is disposed in the circuit board (not shown) of the network transmit/receive port 100, and electrically coupled to the powered device controller unit 30, for controlling a first voltage value of the DC voltage output by the powered device controller unit 30 into a second voltage value for being output to a secondary circuit by current-mode. It can be configured with external component changes to flyback, forward, or non-synchronous low-side switch buck topologies. Both non-isolated and isolated topologies are supported.

The rectifying unit 20 in the above embodiments furthers includes a protection circuitry.

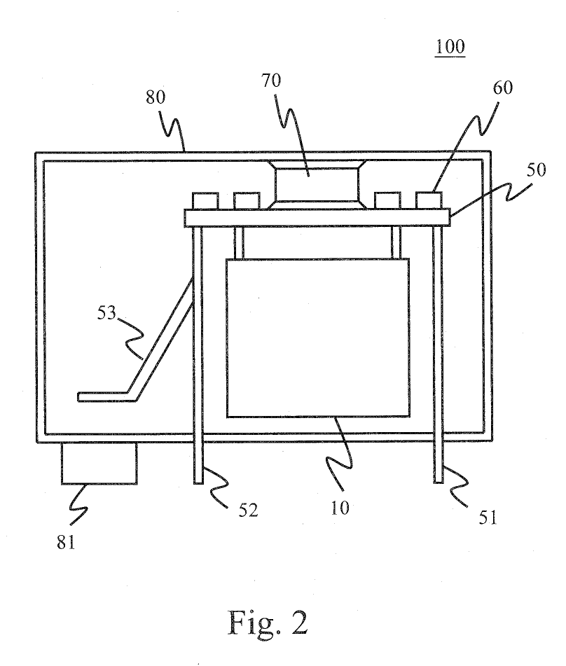

Referring to FIG. 2, it is a schematic cross-sectional view of a structure according to the embodiment of the present invention. As shown in FIG. 2, the network transmit/receive port 100 of the present invention includes transformers 10, a printed circuit board 50, first connection pins 51, second connection pins 52, third connection pins 53, electronic parts 60, a heat sink element 70, a case 80, and a fixing portion 81.

Firstly, the case 80 of the network transmit/receive port 100 has an accommodating space for accommodating the transformers 10, the printed circuit board 50, the first connection pins 51, the second connection pins 52, the third connection pins 53, the electronic parts 60, and the heat sink element 70. The case 80 may be but not limited to a RJ connector case.

The fixing portion 81 is formed on one side of the case 80, for fixing the network transmit/receive port 100 on a carrying structure (not shown), and the case 80 is made of a non-conductive material (for example, plastic).

A plurality of electronic parts 60 is disposed on one surface of the printed circuit board 50, and the electronic parts 60 are, for example, circuit combinations of the rectifying unit 20, the powered device controller unit 30, or the DC-DC converter controller 40 (referring to FIGS. 1A, 1B, and 1C, respectively). The heat sink element 70 is disposed on the electronic parts 60 of the printed circuit board 50, for dissipating heat energies generated during the operation of the electronic parts 60.

The transformers 10 is disposed under the printed circuit board 50, and the input end and the output end of the transformers 10 are electrically coupled to the printed circuit board 50 and/or pins 52. In addition, those skilled in the art can easily know that, the electronic parts 60 can be disposed on the other surface of the printed circuit board 50, or simultaneously disposed on the upper and lower surfaces of the printed circuit board 50.

The first connection pins 51 are disposed on one side of the printed circuit 50, and extends out of the case 80 from the printed circuit board 50. The first connection pins 51 are made by a metal conductive material, and electrically coupled to the electronic parts 60 on the printed circuit board 50, for being electrically coupled to the secondary circuit.

The second connection pins 52 are disposed on the other side of the printed circuit 50, and extends out of the case 80. The second connection pins 52 are made by a metal conductive material, and electrically coupled to the electronic parts 60 on the printed circuit board 50, for being electrically coupled to the secondary circuit.

The third connection pins 53 is made by a metal conductive material, and electrically coupled to the printed circuit board 50 and transformers 10, for being used as a connection end point for the network transmit/receive port 100 to be connected to an external apparatus.

To sum up, in the network transmit/receive port of the present invention, the transformers, the rectifying unit, the powered device controller unit, and the DC-DC converter controller are disposed within the residual space in the network transmit/receive port. The network transmit/receive port uses high lever integration of the transformers, line filters, the rectifying unit, the powered device controller unit and the DC-DC converter controller in the RJ connector case. Therefore, the size and the volume of the circuit board for the electronic device at the power sourcing end or the powered end can be reduced. Not only the integration of the network transmit/receive port is improved, but the network transmit/receive port is also made to have various functions, such as noise isolating, rectifying, voltage stabilizing, and voltage converting, which thus invisibly enhances the competitive advantage of the electronic products.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A network transmit/receive port, comprising:
a printed circuit board;
transformers, disposed under the printed circuit board, for directing power and coupling and filtering data to a physical layer device;
a rectifying unit, disposed on the printed circuit board, and electrically coupled to the transformer and/or spare lines, for accepting power of either polarity at each of its inputs from the transformers and/or spare lines; and
a case, for accommodating the transformers and the rectifying unit.

2. The network transmit/receive port as claimed in claim 1, further comprises a powered device controller unit, disposed on the printed circuit board, and electrically coupled to the rectifying unit and protection circuitry, for providing a resistance for signature detection, providing classification currents for power classification, providing power to a powered device, and managing power, thermal protection overrides, and UVLO.

3. The network transmit/receive port as claimed in claim 2, further comprises a DC-DC converter controller, disposed on the printed circuit board, and electrically coupled to the powered device controller unit, which is configured with external component.

4. The network transmit/receive port as claimed in claim 1, further comprising a heat sink element disposed on an electronic part of the printed circuit board, for dissipating heat energies generated during the operation of the electronic part.

5. The network transmit/receive port as claimed in claim 1, wherein the rectifying unit is a bridge rectifier.

6. The network transmit/receive port as claimed in claim 1, wherein the rectifying unit further comprises a protection circuitry.

7. The network transmit/receive port as claimed in claim 1, wherein the case is a RJ connector case.
